(19) United States
(12) Patent Application Publication
(10) Pub. No.: US 2024/0393433 A1
(43) Pub. Date: Nov. 28, 2024

(54) METHOD FOR AUTHENTICATING AN OBJECT, AND MOBILE CONSUMER DEVICE

(71) Applicant: Infineon Technologies AG, Neubiberg (DE)

(72) Inventors: Klaus ELIAN, Alteglofsheim (DE); Walter HARTNER, Bad Abbach (DE); Horst THEUSS, Wenzenbach (DE); Christian GEIßLER, Teugn (DE); Rainer Markus SCHALLER, Aichen (DE)

(21) Appl. No.: 18/669,157

(22) Filed: May 20, 2024

(30) Foreign Application Priority Data
May 23, 2023 (DE) 102023204788.8

(51) Int. Cl. G01S 7/41

(52) U.S. Cl. CPC G01S 7/415

(57) ABSTRACT

A method for authenticating an object includes positioning a millimeter-wave transceiver relative to an object which contains a metamaterial marking. A transmit signal is transmitted from the millimeter-wave transceiver in the direction of the metamaterial marking, wherein the transmit signal is converted based on the metamaterial marking into a receive signal which has a first characteristic and is emitted in the direction of the millimeter-wave transceiver. The receive signal is received and processed by the millimeter-wave transceiver in order to capture the first characteristic. First comparison information is generated based on the first characteristic and an authentication of the object is carried out based on the first comparison information.

### CROSS-REFERENCE TO RELATED APPLICATION

This application claims priority to German Patent Application No. 102023204788.8 filed on May 23, 2023, the content of which is incorporated by reference herein in its entirety.

### TECHNICAL FIELD

The present disclosure relates to a method for authenticating an object, and a mobile consumer device.

### BACKGROUND

In many areas of daily life, it is desirable to verify the authenticity of an object. An authentication, e.g., a verification of the authenticity of the object in terms of the characteristic or property which the object defines may be necessary or desirable, for example in the verification of official documents, such as certificates, identity documents, passes or official confirmations, in order to detect counterfeits or modifications. A further example comprises the desire of purchasers of objects, such as, for example, special branded products, to verify the authenticity of the products in terms of whether the product was actually produced by the company which is indicated, for example, by a brand logo attached to the object. Many consumers would like to carry out a verification themselves in a simple manner in order to obtain assurance of the origin of the object during the purchasing procedure or following the purchase.

It is therefore desirable to provide a concept with which an object can be authenticated in a simple manner.

### SUMMARY

The present application discloses a method for authenticating an object which includes positioning a millimeter-wave transceiver relative to an object which contains a metamaterial marking. A transmit signal is transmitted from the millimeter-wave transceiver in the direction of the metamaterial marking, wherein the transmit signal is converted based on the metamaterial marking into a receive signal which has a first characteristic and is emitted in the direction of the millimeter-wave transceiver. The receive signal is received and processed by the millimeter-wave transceiver in order to capture the first characteristic. First comparison information is generated based on the first characteristic and an authentication of the object is carried out based on the first comparison information.

The present application further provides a mobile consumer device having a millimeter-wave transmitter circuit for transmitting a millimeter-wave transmit signal, and a millimeter-wave receiver circuit for receiving a millimeter-wave receive signal from an object. The mobile object has a processing circuit to capture at least one characteristic of the millimeter-wave receive signal, and a device for generating first comparison information for the authentication based on the captured first characteristic.

A person skilled in the art will recognize further features and advantages of the implementation when reading the following detailed description and studying the attached drawings.

### BRIEF DESCRIPTION OF THE DRAWINGS

The present disclosure is illustrated by way of example and in a non-restricting manner in the figures of the attached drawings in which the same reference signs relate to similar or identical elements. The elements in the drawings are not necessarily drawn to scale in relation to one another. The features of the different examples shown can be combined, unless they are mutually exclusive.

FIG. 1A shows a document object according to one example.

FIG. 1B shows the document object according to FIG. 1A with a partial section of an inside of the document object.

FIG. 1C shows a mobile consumer device for authenticating the document object according to FIGS. 1A and 1B.

FIG. 1D shows a further mobile consumer device for authenticating the document according to FIGS. 1A and 1B.

FIG. 2 shows a flow diagram for authenticating an object according to one example.

FIG. 3A shows metamaterial structures according to one example.

FIG. 3B shows transmission spectra of the metamaterial structures according to one example.

FIG. 4A shows the front page of a document object according to one example.

FIG. 4B shows the back page of a document object according to one example.

FIG. 4C shows the document object according to FIGS. 4A and 4B in a transparent view.

FIG. 4D shows a cross section through the document object according to FIGS. 4A, 4B and 4C.

FIG. 5 shows a document object and a further substrate for authenticating the document object.

FIG. 6 shows a semiconductor chip having a metamaterial marking according to one example.

### DETAILED DESCRIPTION

In different implementations, the following description discloses a novel concept for authenticating objects. The concept is based on the use of millimeter waves and corresponding metamaterials which are suitable for modifying millimeter waves.

Due to the already widespread use of millimeter-wave transceivers, for example in smartphones or smartwatches, authentication that is simple for the user can already be provided without excessive or additional circuit outlay. The use of metamaterials further allows a modification of the millimeter waves necessary for the authentication in an economical and compact manner.

The implementations described here therefore enable an authentication of an object in a simple and economical manner.

It should be noted that the description and the drawings merely illustrate the principles of the proposed methods and devices. A person skilled in the art will be able to implement different arrangements which, although they are not expressly described or shown here, embody the principles of the implementation and are contained within the scope thereof. In addition, all examples and implementations which are outlined in the present document are essentially and expressly intended for explanatory purposes only, in order to help the reader to understand the principles of the proposed methods and devices. In addition, all statements in this document which describe principles, aspects and implementations of the implementation and specific examples thereof also comprise equivalents thereof. In particular, the concept described by way of example for a document object can be applied in a similar manner to the authentication of other objects, such as, for example, clothing, shoes, motor vehicles, official documents, semiconductor products, etc.

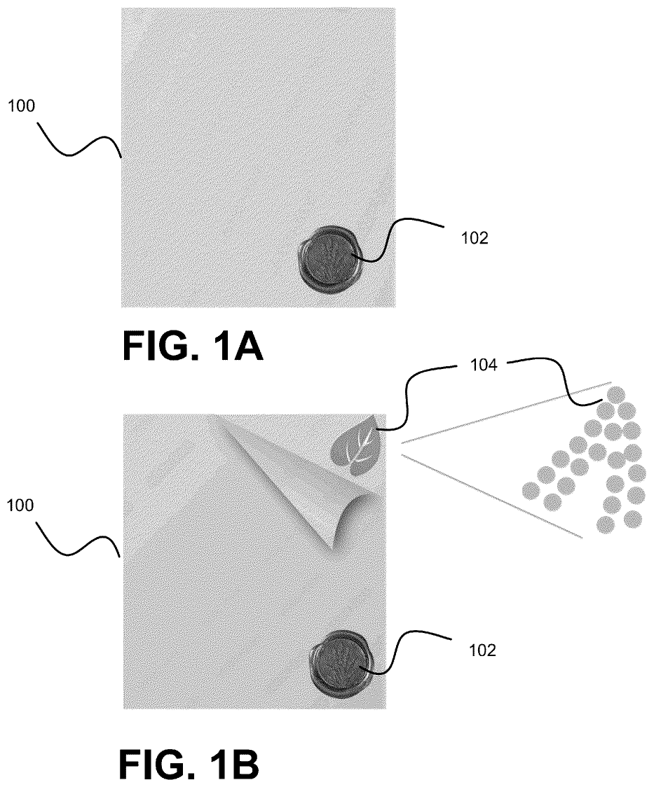

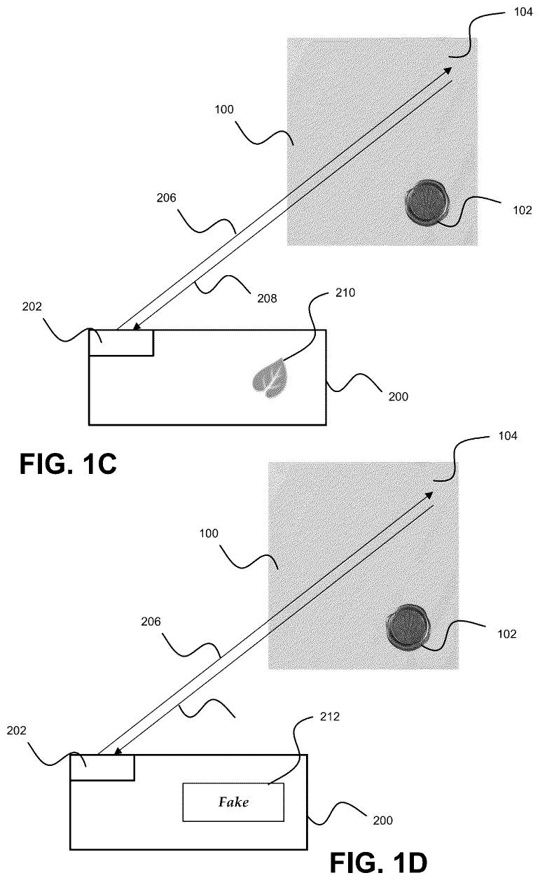

Examples according to the present description will now be explained with reference to FIGS. 1A to 1D. FIG. 1A shows an external view of an object 100 which represents a document, for example a certificate, having a visual marking 102 attached thereto. The visual marking 102 can be, for example, a seal (as shown in FIG. 1A), a signature or a trademark, and is typically attached to or integrated into the object 100 in order to indicate to the user and other persons that the object 100 has a specific characteristic or property.

The characteristic or property which is defined by the visual marking 102 can be, for example, a property as an official document, such as e.g., a certificate, an identity document, a pass, an official confirmation or other official document. In other examples, the characteristic can comprise a property indicating that a special branded product is involved in which a brand name, logo or other symbol of the company indicates the particular origin of the product.

Objects which are based on the fact that they have a specific characteristic are essentially susceptible to counterfeits, modifications or other types of manipulations. It is therefore desirable for many consumers themselves to be capable of carrying out an authentication, e.g., a verification of the defined characteristic or property. The authentication should further be possible in a simple and uncomplicated manner in order to make it accessible to the widest possible group of people.

For this purpose, a metamaterial marking 104 which is not visible to the observer is incorporated into the object 100. FIG. 1B shows a partial section of the object in which the metamaterial marking 104, which is not visually perceptible from outside, can be seen. The metamaterial marking 104 has a predetermined shape (a leaf shape in FIG. 1B) and a predefined position within the object (top right in FIG. 1B). The metamaterial marking 104 further has a specific alignment, for example with the tip of the leaf shape pointing upward.

FIG. 1C shows a mobile consumer device 200 which can be used to authenticate the object 100. The mobile consumer device 200 can be, in particular, a wireless communication device, such as, for example, a smartphone, a tablet or a laptop, etc. the mobile consumer device 200 has a millimeter-wave transceiver 202 which transmits a transmit signal 206 at a frequency in the millimeter-wave range via an antenna system (for example an antenna array) to the object 100. The frequency in the millimeter-wave range can be, for example, a frequency in the frequency band from 30 GHz to 500 GHz. The metamaterial marking 104 converts the transmit signal 206 into a receive signal 208 so that the receive signal 208 is transmitted back to the antenna system of the millimeter-wave transceiver 202.

The receive signal 208 has at least one predetermined characteristic, for example a phase, frequency, beam direction, etc., which is impressed into the receive signal 208 by the metamaterial marking 104, for example by modifying the characteristic of the transmit signal 206. The metamaterial marking 104 can effect, for example, a phase change relative to a phase of the transmit signal 206, an amplitude change, a modification of the frequency behavior relative to the frequency of the transmit signal 206, or a specific emission in one direction. The metamaterial marking 104 can effect, for example, a reflection so that the receive signal 208 represents a signal reflected by the metamaterial marking 104. In other examples, the metamaterial marking 104 can effect a transmission so that the receive signal 208 represents a signal transmitted by the metamaterial marking 104. The receive signal 208 is captured by the mobile consumer device 200. Here, the reflection reveals itself, in particular, as advantageous for use in mobile consumer devices in particular, since both the transmitter and the receiver of the millimeter-wave transceiver of a mobile consumer device can be used for transmission or reception. This enables simple and uncomplicated handling.

Based on the captured characteristic, for example the beam directions of the receive signal 208 transmitted back to the millimeter-wave transceiver, a shape or alignment, for example, of the metamaterial marking 104 can be captured and can be displayed according to FIG. 1C as first comparison information 210 on a screen of the mobile consumer device 200. The millimeter-wave transceiver can be configured, in particular, as an imaging millimeter-wave transceiver, thus enabling a highly precise capture of position and shape. Cascaded millimeter-wave chips having corresponding antenna arrays can also be used for this purpose.

An amplitude, a frequency or a phase position, for example, can further be captured as a characteristic and can, for example, be converted into a color scheme which is displayed on the screen of the mobile consumer device 200 as first comparison information 210.

The first comparison information 210 displayed to the user enables an authentication of the object 100 to be carried out. If the displayed first comparison information 210 is identical or similar to predetermined second comparison information, the object 100 can be authenticated as trustworthy. The predetermined second comparison information can be known to the user, for example if the second comparison information represents generally known information or information known to the user, such as, for example, the shape, alignment and color of a generally known logo.

In other examples, the predetermined second comparison information can be unknown to the user and can either be stored in a memory of the mobile consumer device or transmitted in real time onto the mobile consumer device 200, for example via a secure wireless communication connection. The comparison between the displayed first comparison information and the predetermined second comparison information can be carried out, for example, visually by the user, and the user himself decides whether he classifies the object as trustworthy. The second comparison information can also contain, for example, time information, for example a year of manufacture of the object, or identification information such as, for example, a serial number. Corresponding information should then obviously be similarly contained or encoded in the metamaterial marking 104.

In a further example which is shown in FIG. 1D, the comparison between the captured first comparison information and the predetermined second comparison information can be carried out by the mobile consumer device 200 itself, for example in a data processing unit of the mobile consumer device 200. To do this, the data processing unit can compare the first information obtained from the captured characteristics with second comparison information. With corresponding algorithms, a decision can be made as to whether the first comparison information matches or approximately matches the second comparison information. The advantage of using a mobile consumer device is evident here also, since corresponding data processing facilities are already present in smartphones, tablets, etc. In particular, the comparison can also be initiated and carried out in an app of the smartphone or tablet.

The result of the decision can be displayed visually on the screen. If the discrepancies between the captured first comparison information and the predetermined second comparison information are too great, the display can indicate that the object is an untrustworthy object, for example a fake object.

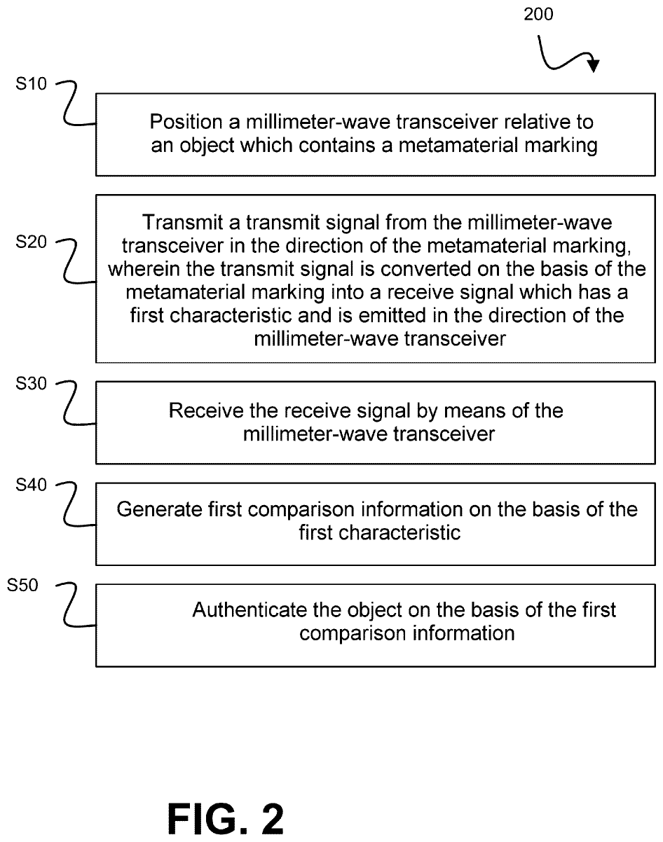

The fundamental procedure of the authentication will now be explained briefly with reference to FIG. 2. In a step S10, a millimeter-wave transceiver is positioned relative to an object containing a metamaterial marking. In a step S20, a transmit signal is emitted from a millimeter-wave transceiver in the direction of the metamaterial marking, wherein the transmit signal is converted based on the metamaterial marking into a receive signal which has a first characteristic and is emitted in the direction of the millimeter-wave transceiver. In a step S30, the receive signal is received by the millimeter-wave transceiver, and, in step S40, first comparison information is generated based on the first characteristic. In a step S50, the object is authenticated based on the first comparison information.

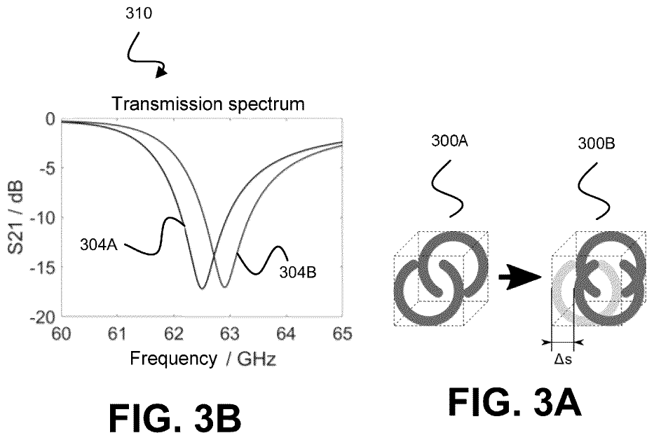

An example of a metamaterial marking and a generation of the characteristics will now be explained with reference to FIG. 3A. A metamaterial is a material which is configured to have characteristics which do not occur in natural materials. A metamaterial is a material which is configured in such a way that it has a characteristic which cannot be found in naturally occurring materials. It is produced from a multiplicity of structural elements which are manufactured from composite materials such as metals or plastics. The materials can be arranged in repeating or periodic patterns, and in orders of magnitude which are smaller than the wavelengths of the phenomena which they influence. In other words, metamaterials achieve the desired effects by containing structural elements with sizes below the wavelength, e.g., features which are actually smaller than the wavelength of the electromagnetic waves influenced by them.

Consequently, metamaterials do not necessarily derive their properties from the properties of the base materials, but from their structural design. Their precise shape, geometry, size, alignment and arrangement of the structural elements gives the metamaterials their special properties with which they can manipulate electromagnetic waves: through blocking, reflection, absorption, amplification or deflection of waves or direction-dependent emission. A metamaterial is therefore defined as an artificial composite material which derives its electrical properties from its precisely configured structures and their arrangement, instead of inheriting them directly from the materials from which it is composed.

A metamaterial can be a subgroup of a larger group of heterogeneous structures which consist of a solid base material and elements made from a different material. Metamaterials are characterized in that they have special, sometimes anomalous, properties in a limited frequency band. Millimeter-wave metamaterials can have, for example, special properties in a millimeter band, e.g., the aforementioned frequency band between 30 GHz and 500 GHz.

In connection with the examples described, a metamaterial is a two-dimensional (2 D) or three-dimensional (3 D) arrangement of elementary structures which are coupled to one another. “Elementary structures”, as used here, can be referred to as discrete structures, element structures or a combination thereof. In some cases, the elementary structures can also be referred to simply as “structures”.

The arrangement as a whole offers macroscopic properties which can be shaped by the elementary structures that are used and their coupling paths. Metamaterials are configured for different types of waves, such as electromagnetic waves (e.g., optical, infrared (IR) and mm-waves), and mechanical waves (e.g., ultrasound). The size of the elementary structures and their grid spacing are scaled with the wavelength of the target frequency range.

The elementary structures of metamaterials can be applied to objects, for example, using printing methods, thus enabling a very economical manufacturing method.

Elementary structures for millimeter-wave metamaterials can be resonator elements, antenna elements, filter elements, waveguide elements, transmission line elements or a combination thereof. Elementary structures 300A and 300B, which are formed in each case by two open ring elements, are shown purely by way of example in FIG. 3A. The size of the elementary structure can extend to a plurality of wavelengths, but is normally less than one wavelength. They consist of parts which generate magnetic fields (e.g., conductor rings), and other parts which generate electrical fields (e.g., gaps between conductors). In addition, they can also contain elements which have electromagnetic wave properties, such as e.g., a short transmission line segment.

A characteristic which is influenceable by the millimeter-wave metamaterial can be modified by shifting the two ring elements relative to one another. The elementary structure 300B has a lower ring element which is shifted by an amount Δs in relation to the corresponding ring element of the elementary structure 300A, as a result of which an electromagnetic coupling between the two ring elements is modified.

FIG. 3B shows the effect on the frequency characteristic based on the respective transmission spectra 310. A shift of the resonant frequency and generally a shift of the transmission spectrum 302B which is assigned to the elementary structure 300B, compared with the transmission spectrum 302A, which is assigned to the elementary structure 300A, can be observed.

The modified frequency characteristic can be exploited, for example, by determining the resonant frequency. A phase change, for example, can also be observed and determined in a similar manner.

In examples, it can therefore be provided that the metamaterial marking 104 has different characteristics at different positions (for example different couplings due to different distances between the elementary structures), as a result of which the characteristic of the millimeter waves transmitted back is dependent on the position of the reflection. In some examples, the characteristic can change continuously over an entire area of the metamaterial marking 104. A replication or falsification of the metamaterial marking 104 therefore requires precise information relating to the structure and geometry of the elementary structures over the entire area of the metamaterial marking 104, thus making it significantly more difficult for potential fraudsters to falsify or copy products.

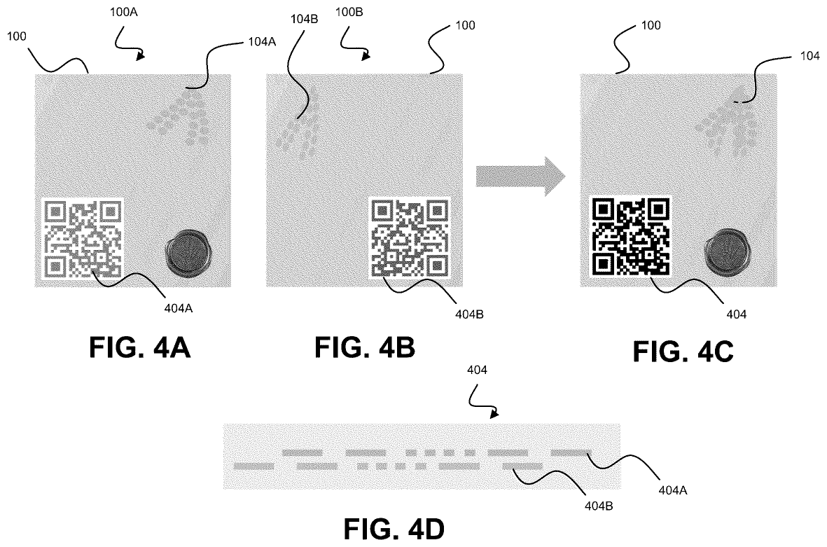

Examples of an integration of metamaterial markings will now be described with reference to FIG. 4A to 4D. In the examples shown in FIG. 4A to 4D, different metamaterial markings are integrated in each case into different layers of the object 100. The metamaterial markings can differ, for example, in size, shape and alignment. FIG. 4A shows a cross section of the front page as an open front view 100A of the object 100. A first metamaterial marking 104A having a first shape at a first position, and a second metamaterial marking 404A having a second shape at a second position can be seen in the front view. The metamaterial markings 104A and 404A are located in a first layer of the object 100. FIG. 4B shows a cross section of the back page as an open rear view 100B in which a third metamaterial marking 104B is located at the first position, and a fourth metamaterial marking 404B is located at the second position. The metamaterial markings 104B and 404B are located in a second layer of the object 100.

The metamaterial markings 104A and 104B are positioned in the object 100 in such a way that the first metamaterial marking 104A and the second metamaterial marking 104B are actively coupled so that a combined metamaterial marking 104 is produced by coupling the two metamaterial markings in a shape which is influenced by both metamaterial markings 104A and 104B, as shown in FIG. 4C. In other words, the metamaterial markings 104A and 104B represent partial markings of the metamaterial marking 104.

In a corresponding manner, the metamaterial markings 404A and 404B are positioned in the object 100 in such way that the third metamaterial marking 404A and the fourth metamaterial marking 404B are actively coupled so that a combined metamaterial marking 404 is produced by coupling the two metamaterial markings in a shape which is influenced by both metamaterial markings 404A and 404B. The third and fourth metamaterial markings 404A and 404B have a two-dimensional pattern here which is similar to a QR code and is formed by smaller rectangular units and can, in particular, represent a code. A whole code formed from the individual sub-codes of the metamaterial markings 404A and 404B is produced by coupling the two metamaterial markings 404A and 404B.

The metamaterial markings 404A and 404B are similarly arranged in different layers of the object 100 as shown for a section in FIG. 4D. FIG. 4D shows a cross section of the object 100 at the second position. It is evident that the third metamaterial marking 404A is arranged in a layer above the fourth metamaterial marking 404B.

The authentication is performed according to the examples described in FIG. 1A to 1D and FIG. 2, but it should be noted that a plurality of different metamaterial markings are present in the object. The millimeter waves transmitted back by the metamaterial marking 104 at the first position are captured accordingly and converted into first comparison information corresponding to the first position. This information is compared with predetermined second comparison information corresponding to the first position, wherein the predetermined second comparison information is produced from a predetermined shape which incorporates both sub-shapes.

In a similar manner, the millimeter waves transmitted back by the metamaterial marking 404 at the second position are captured accordingly and converted into first comparison information corresponding to the second position. The capture can take place either simultaneously, as in an imaging millimeter wave sensor, or through temporally consecutive analog beam scanning. The millimeter waves transmitted back from the metamaterial marking 404 at the second position are converted into first comparison information which is compared with predetermined second comparison information corresponding to the second position.

The relative distance between the first position corresponding to the first metamaterial marking 104 and the second position corresponding to the second metamaterial marking can additionally be determined as further information for the verification. Similarly, further information, such as, for example, the relative distance between the first position and the second position in relation to the size of the metamaterial marking 104 and/or the size of the metamaterial marking 404 can also be used.

In other examples, metamaterial markings can be provided at more than two positions. The additional information, for example, indicating how many metamaterial markings are present at spatially separated positions can be used as first or second comparison information for the authentication.

It is clear that the formation of a metamaterial marking which is composed of sub-metamaterial markings which are separated vertically in space from one another (e.g., in different layers of the object 100) and/or are separated laterally in space from one another (e.g., at different lateral positions) creates increased complexity which enables additional information to be used for the authentication, thus making it more difficult for counterfeiters to falsify or manipulate the object 100.

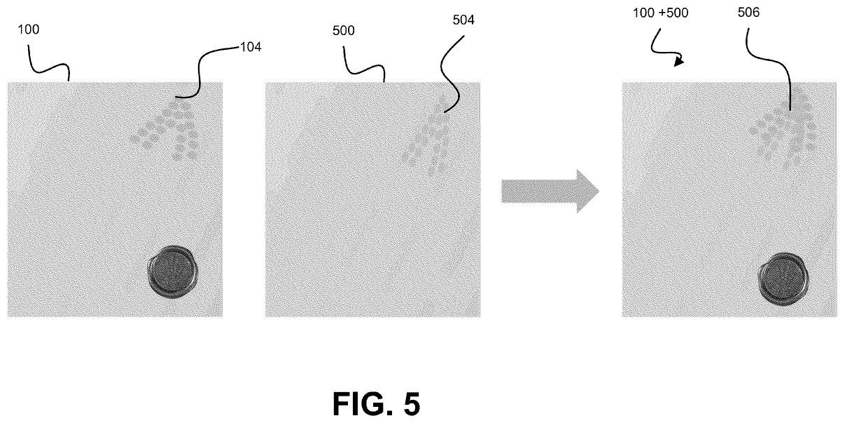

An example in which a metamaterial marking incorporated into the object 100 forms a combined metamaterial marking through relative positioning of a carrier which has a further metamaterial marking will be explained with reference to FIG. 5.

In FIG. 5, the object 100 has a metamaterial marking 104 in the upper right area, as already explained with reference to FIGS. 1A to 1D. A carrier 500 similarly has a metamaterial marking 504 in an upper right area, wherein, however, the shapes of the two metamaterial markings 104 and 504 differ from one another. For authentication, the carrier 500 is positioned relative to the object 100, for example by overlaying the object 100 and the carrier 500. In the combined state, a combined metamaterial marking 506 is formed by the two metamaterial markings 104 and 504. As already explained above, the authentication is performed based on the combined metamaterial marking 506. A successful authentication can be performed, for example, only if both metamaterial markings 104 and 504 are present with the correct shape and in the correct position. This requires the carrier 500 to be positioned in a unique manner relative to the object 100, and this is simplified, for example, by a matching size and shape of the object 100 and of the carrier 500. In some examples, markings can also be provided which simplify the positioning of the carrier 500 relative to the object 100.

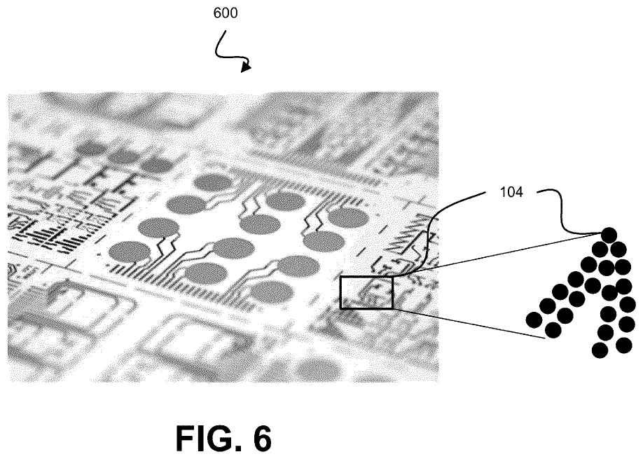

A further example of a use of metamaterial markings for authentication will be described with reference to FIG. 6. FIG. 6 shows a semiconductor chip 600 having a metal layer which forms respective elements of the semiconductor chip. A metamaterial marking 104 indicating the identity of the semiconductor chip is embedded in one area of the semiconductor chip. In order to verify the semiconductor chip, as already described above, it is established, based on a characteristic of the beam transmitted back from the metamaterial marking 104 and on a generation of comparison information, whether the semiconductor chip is an original or a counterfeit.

In summary, a wide variety of examples and fields of application are described for an authentication which is simple to carry out and which can be carried out using mobile consumer objects such as smartphones or tablets having an integrated millimeter-wave transceiver.

### Aspects

In addition to the aspects described above, aspects of methods and devices, in particular, are disclosed as set out below.

Aspect 1 is a method for authenticating an object, comprising the following steps: positioning a millimeter-wave transceiver relative to an object which contains a metamaterial marking; transmitting a transmit signal from the millimeter-wave transceiver in the direction of the metamaterial marking, wherein the transmit signal is converted based on the metamaterial marking into a receive signal which has a first characteristic and is emitted in the direction of the millimeter-wave transceiver; receiving the receive signal using the millimeter-wave transceiver; processing the receive signal in order to capture the first characteristic; generating first comparison information based on the first characteristic; and authenticating the object based on the first comparison information.

Aspect 2 is a method according to Aspect 1, wherein processing the receive signal comprises capturing at least one of the following characteristics: a beam direction of the receive signal; a phase position of the receive signal; a phase position of the receive signal in one beam direction; a frequency of the receive signal; a frequency of the receive signal in one beam direction; an amplitude of the receive signal; or an amplitude of the receive signal in one beam direction.

Aspect 3 is a method according to Aspect 2, wherein authenticating the object comprises: comparing the first comparison information with predetermined second comparison information.

Aspect 4 is a method according to Aspect 2 or 3, wherein authenticating the object comprises at least one of the following steps: determining a position of the metamaterial marking and comparing it with a predetermined position; determining a shape of the metamaterial marking and comparing it with a predetermined shape; determining a size of the metamaterial marking and comparing it with a predetermined size of the metamaterial marking; determining a number of spatially separated metamaterial markings on the object and comparing it with a predetermined number; or determining relative distances between spatially separated metamaterial markings.

Aspect 5 is a method according to one of Aspects 3 or 4, wherein the predetermined second comparison information comprises time information or identification information to identify the object.

Aspect 6 is a method according to one of Aspects 3 to 5, wherein the millimeter-wave transceiver is implemented in a mobile consumer device, and wherein the predetermined second comparison information is stored in the mobile consumer device or is loaded via a wireless connection onto the consumer device.

Aspect 7 is a method according to Aspect 6, wherein the comparison of the first comparison information with predetermined second comparison information is carried out by a circuit or software in the mobile consumer device.

Aspect 8 is a method according to one of Aspects 1 to 7, wherein the metamaterial marking has a first sub-marking and a second sub-marking which are spatially separated.

Aspect 9 is a method according to one of Aspects 1 to 8, wherein the metamaterial marking is a first metamaterial marking and the method further comprises: positioning a second metamaterial marking relative to the object in such a way that the first and second metamaterial marking are actively coupled, wherein the second metamaterial marking is arranged on a carrier separate from the object, wherein the transmit signal is converted based on the first metamaterial marking and the second metamaterial marking into a receive signal which has the first characteristic and is emitted in the direction of the millimeter-wave transceiver.

Aspect 10 is a method according to one of the preceding aspects, wherein the method further comprises at least one of the following steps: presenting, based on the captured first characteristic, a shape of the metamaterial marking on an image display; or presenting, based on the captured first characteristic, authenticity information which indicates whether the object has been determined as authentic.

Aspect 11 is a mobile consumer device having the following features: a millimeter-wave transmitter circuit for transmitting a millimeter-wave transmit signal and a millimeter-wave receiver circuit for receiving a millimeter-wave receive signal from an object; a processing circuit to capture at least one characteristic of the millimeter-wave receive signal and a device for generating first comparison information for the authentication based on the captured first characteristic.

Aspect 12 is a mobile consumer device according to Aspect 11, further having an authentication device which is configured to carry out a comparison between the first comparison information and predetermined second comparison information.

Aspect 13 is a mobile consumer device according to one of Aspects 11 or 12, wherein the processing circuit is configured to capture at least one of the following characteristics based on the receive signal: a beam direction of the receive signal; a phase position of the receive signal; a phase position of the receive signal in one beam direction; a frequency of the receive signal; a frequency of the receive signal in one beam direction; an amplitude of the receive signal; or an amplitude of the receive signal in one beam direction.

Aspect 14 is a mobile consumer device according to one of Aspects 12 or 13, wherein the mobile consumer device has a least one of the following features: a memory to store predetermined second comparison information, or a wireless communication interface to load the predetermined second comparison information wirelessly.

Aspect 15 is a mobile consumer device according to one of Aspects 12 to 14, wherein the authentication device is configured to carry out at least one of the following steps: determining a position of the metamaterial marking and comparing it with a predetermined position; determining a shape of the metamaterial marking and comparing it with a predetermined shape; determining a size of the metamaterial marking and comparing it with a predetermined size of the metamaterial marking; determining a number of spatially separated metamaterial markings on the object and comparing it with a predetermined number; or determining relative distances between spatially separated metamaterial markings.

Aspect 16 is a mobile consumer device according to one of Aspects 11 to 15, wherein the mobile consumer device has a display circuit in order to display a shape of the first metamaterial marking or information indicating the authenticity of the object based on the captured first characteristic.

Aspect 17 is a method for authenticating an object comprising the following steps: positioning the object which has a first material marking relative to a carrier which has a second material marking so that the first metamaterial marking is actively coupled to the second metamaterial marking; transmitting a transmit signal generated by a millimeter-wave transmit circuit in the direction of the first and second metamaterial marking, wherein the transmit signal is converted based on the actively coupled first and second material markings into a receive signal which has a first characteristic; receiving the receive signal using a millimeter-wave receive circuit; processing the receive signal in order to capture the first characteristic; and authenticating the object based on the captured first characteristic.

1. A method for authenticating an object, comprising:
positioning a millimeter-wave transceiver relative to an object which contains a metamaterial marking;
transmitting a transmit signal from the millimeter-wave transceiver in the direction of the metamaterial marking, wherein the metamaterial marking causes the transmit signal to be converted into a receive signal, wherein the receive signal has a first characteristic and is emitted in a direction of the millimeter-wave transceiver;
receiving the receive signal via the millimeter-wave transceiver;
processing the receive signal to capture the first characteristic;
generating first comparison information based on the first characteristic; and
authenticating the object based on the first comparison information.

2. The method as claimed in claim 1, wherein processing the receive signal comprises capturing at least one of:
a beam direction of the receive signal;
a phase position of the receive signal;
a phase position of the receive signal in one beam direction;
a frequency of the receive signal;
a frequency of the receive signal in one beam direction;
an amplitude of the receive signal; or
an amplitude of the receive signal in one beam direction.

3. The method as claimed in claim 2, wherein authenticating the object comprises:
comparing the first comparison information with predetermined second comparison information.

4. The method as claimed in claim 2, wherein authenticating the object comprises at least one of:
determining a position of the metamaterial marking and comparing the position of the metamaterial marking and a predetermined position;
determining a shape of the metamaterial marking and comparing the shape of the metamaterial marking and a predetermined shape;
determining a size of the metamaterial marking and comparing the size of the metamaterial marking and a predetermined size of the metamaterial marking
determining a number of spatially separated metamaterial markings on the object and comparing the number of spatially separated metamaterial markings and a predetermined number; or
determining relative distances between the spatially separated metamaterial markings.

5. The method as claimed in claim 3, wherein the predetermined second comparison information comprises time information or identification information to identify the object.

6. The method as claimed in claim 3, wherein the millimeter-wave transceiver is implemented in a mobile consumer device, and wherein the predetermined second comparison information is stored in the mobile consumer device or is loaded via a wireless connection onto the mobile consumer device.

7. The method as claimed in claim 6, wherein the comparison of the first comparison information and the predetermined second comparison information is carried out by a circuit or software in the mobile consumer device.

8. The method as claimed in claim 1, wherein the metamaterial marking has a first sub-marking and a second sub-marking which are spatially separated.

9. The method as claimed in claim 1, wherein the metamaterial marking is a first metamaterial marking, and wherein the method further comprises:
positioning a second metamaterial marking relative to the object to cause the first metamaterial marking and the second metamaterial marking to be actively coupled, wherein the second metamaterial marking is arranged on a carrier separate from the object, wherein the transmit signal is converted, based on the first metamaterial marking and the second metamaterial marking, into the receive signal which has the first characteristic and is emitted in a direction of the millimeter-wave transceiver.

10. The method as claimed in claim 1, wherein the method further comprises at least one of:
presenting, based on the first characteristic, a shape of the metamaterial marking on an image display; or
presenting, based on the first characteristic, authenticity information which indicates whether the object has been determined as authentic.

11. A mobile consumer device comprising:
a millimeter-wave transmitter circuit configured to transmit a millimeter-wave transmit signal;
a millimeter-wave receiver circuit configured to receive a millimeter-wave receive signal from an object;
a processing circuit configured to capture at least one characteristic of the millimeter-wave receive signal; and
a device configured to generate first comparison information configured to determine an authentication based on the at least one characteristic.

12. The mobile consumer device as claimed in claim 11, further comprising:
an authentication device configured to carry out a comparison between the first comparison information and predetermined second comparison information.

13. The mobile consumer device as claimed in claim 11, wherein the processing circuit is configured to capture, based on the millimeter-wave receive signal, at least one of:
a beam direction of the millimeter-wave receive signal;
a phase position of the millimeter-wave receive signal;
a phase position of the millimeter-wave receive signal in one beam direction;
a frequency of the millimeter-wave receive signal;
a frequency of the millimeter-wave receive signal in one beam direction;
an amplitude of the millimeter-wave receive signal; or
an amplitude of the millimeter-wave receive signal in one beam direction.

14. The mobile consumer device as claimed in claim 12, wherein the mobile consumer device further comprises at least one of:
a memory to store predetermined second comparison information, or
a wireless communication interface to load the predetermined second comparison information wirelessly.

15. The mobile consumer device as claimed in claim 12, wherein the authentication device is configured to at least one of:
determining a position of a metamaterial marking and comparing the position of the metamaterial marking and a predetermined position;
determining a shape of the metamaterial marking and comparing the shape of the metamaterial marking and a predetermined shape;
determining a size of the metamaterial marking and comparing the size of the metamaterial marking and a predetermined size of the metamaterial marking;
determining a number of spatially separated metamaterial markings on the object and comparing the number of spatially separated metamaterial markings and a predetermined number; or
determining relative distances between the spatially separated metamaterial markings.

16. The mobile consumer device as claimed in claim 11, wherein the mobile consumer device further comprises:
a display circuit configured to display a shape of a metamaterial marking or information indicating an authenticity of the object based on the at least one first characteristic.

17. A method for authenticating an object comprising:
positioning the object which has a first material marking relative to a carrier which has a second material marking so that the first material metamaterial marking is actively coupled to the second material marking;
transmitting a transmit signal generated by a millimeter-wave transmit circuit in a direction of the first material marking and the second metamaterial marking, wherein the transmit signal is converted into a receive signal based on the actively coupled first and second material markings, wherein the receive signal has a first characteristic;
receiving the receive signal via a millimeter-wave receive circuit;
processing the receive signal to capture the first characteristic; and
authenticating the object based on the first characteristic.
